(19) United States
(12) Patent Application Publication
(10) Pub. No.: US 2003/0084243 A1
(43) Pub. Date: May 1, 2003

(54) Access method and storage apparatus of network-connected disk array

(75) Inventors: Satoshi Hoshina, Ome-shi (JP); Toshimitsu Noguchi, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/278,815

(22) Filed: Oct. 24, 2002

(30) Foreign Application Priority Data
Oct. 31, 2001 (JP) 2001-335798

(51) Int. Cl. G06F 12/00

(52) U.S. Cl. 711/114; 711/156

(57) ABSTRACT

There is disclosed a network controller which is disposed in a disk controller and which transmits read fractionated data to a host computer as a requester every read end of each of disk apparatuses having ended the reading without waiting for the read end of the disk apparatuses constituting the disk array.

### CROSS-REFERENCE TO RELATED APPLICATIONS

This application is based upon and claims the benefit of priority from the prior Japanese Patent Application No. 2001-335798 filed Oct. 31, 2001, the entire contents of which are incorporated herein by reference.

### BACKGROUND OF THE INVENTION

1. Field of the Invention

The present invention relates to an access method and storage apparatus of a network-connected disk array.

2. Description of the Related Art

To read/write data in a data size of a logical unit length with respect to an apparatus including a plurality of storage apparatuses such as hard disks, a redundant arrays of inexpensive disks (RAID) apparatus has broadly been known as a technique in which the data to be handled is physically allocated to the plurality of storage apparatuses and the plurality of storage apparatuses are allowed to simultaneously read/write the data in parallel with one another in order to achieve a high speed.

The RAID apparatus usually includes a controller and cache in which the data of disks is stored. Therefore, for example, to access only S data having a block number X, the data having block numbers X/2 to S/2 are stored in a disk apparatus A, and the data having block numbers X/2 to S/2 are stored in a disk apparatus B. The data is fractionated and stored in a plurality of disk apparatuses in this manner, and a behavior as a virtual large-capacity storage apparatus is achieved. In this case, the plurality of disk apparatuses are operated in parallel with one another so that high-speed access can be realized. In this case, a method of allocating the data to the disks and the number of constituting disks have variously been proposed in accordance with applications, aimed capabilities, and cost.

On the other hand, there are a plurality of standards in connecting these RAID apparatuses to a computer main body or equivalent apparatus. Some of the standards are based on a LAN technique which has heretofore been used in connecting the computer main bodies to one another. In this case, examples of a protocol for exchanging the data include simple protocols for normal transmission, discontinuance by an error, and re-transmission, and a complicated protocol for guaranteeing ordinality. For example, iSCSI is based on a transmission control protocol/internet protocol (TCP/IP) as a standard protocol of internet, and the division of data and guarantee of ordinality are performed by the protocol.

In the RAID apparatus, the plurality of storage apparatuses are operated in parallel with one another as described above during the reading of the data so that high speed is achieved. However, depending on physical situations such as seek and rotational latency, a dispersion is generated in data transmission (read process). In this case, because of properties of RAID, in general, when the data transmission of the last disk ends, the data is prepared as requested, and capabilities of the apparatus are influenced by an operation of a slowest disk. In a system of the RAID apparatuses connected to a network using a transmission apparatus as described above, when the read data is all prepared by the parallel operations of the plurality of disk apparatuses, the data transmission onto the network is started. A conventional data transmission example is shown in FIG. 1. Here, for the sake of convenience of description, two disk apparatuses are shown as an example, but the data transmission is performed similarly for three or more disk apparatuses.

In a general RAID technique, to read the data, a read command is issued with respect to two disk apparatuses A, B (Disks A, B) at an optimum timing. However, depending on individual situations of the disk apparatuses, a dispersion is generated at the end of the reading for the above-described reasons. In an example shown in FIG. 1, although the disk apparatus B (Disk B) ends the data transmission (read process) earlier than the disk apparatus A (Disk A), it is necessary to wait for the end of the data transmission of the disk apparatus A (Disk A) (the data transmission of the disk apparatus having read the data lastly) before the data transmission to a host computer. In this manner, an operation is not accurately performed in response to a read request on a main body side until the data of the disk apparatuses A, B (Disks A, B) is prepared. Therefore, the capabilities of the apparatus are influenced by the operation of the slowest disk apparatus, and this has heretofore caused a problem in achieving a higher speed.

FIG. 2 is an explanatory view of an example of data transmission to a host computer in a conventional art in which iSCSI is used as the protocol. In this example, the disk array includes four disk apparatuses. When the data of the four disk apparatuses is prepared, a disk controller transmits the data to the host computer. In this case, to obtain a maximum efficiency, the disk controller divides data at a maximum such that a header of TCP can carry the data as shown, the header of TCP is attached to the data, and first data is transmitted as a packet 201 to the host computer. Subsequently, second data is transmitted as a packet 202. Furthermore, third data is transmitted as a packet 203. To perform these transmissions, all the data of disks 1 to 4 has to be prepared.

It is to be noted that Jpn. Pat. Appln. KOKAI Publication No. 5-250099 (Title of the Invention: High-Speed File Access Control Method and Computer System) includes: a computer system including an interface with an I/O bus having a disconnect/reconnect function; and a plurality of magnetic disk apparatuses connected via the I/O bus. The computer system includes control means for referring to disk management information, file management information, and file descriptor correspondence information, dividing a file during a disk access, and asynchronously reading/writing data with respect to a plurality of disks. However, in the system, the number of disk apparatuses constituting the disk array is known beforehand, when the host computer issues an access request to the file system. The host computer asynchronously issues the access request to the disk controller which controls the disk array. In this case, the host computer knows the number of disk apparatuses constituting the disk array beforehand. Therefore, for example, when the disk array includes three disk apparatuses, three access requests are outputted to the disk controller. The disk controller asynchronously returns packet data to which some ID information has been added to the host computer. The host computer receives the asynchronously transmitted packet data, and reconstitutes the received packet data in accordance with the constitution of the disk array known beforehand.

On the other hand, according to the present invention, the host computer needs not know the number of disks constituting the disk array. Only the disk controller knows the number of disk apparatuses constituting the disk array. Therefore, for example, when the disk array includes three disk apparatuses, the host computer issues one disk access request to the disk controller. The disk controller divides the disk array based on a requested block address and size. The disk controller asynchronously receives the packet data from the disk apparatus, adds information of offset and block size to the data, and returns the data to the host computer.

### BRIEF SUMMARY OF THE INVENTION

An object of the present invention is to provide an access method and storage apparatus of a network-connected disk array in which data read by a plurality of disk apparatuses operating in parallel with one another can efficiently be transmitted at a high speed regardless of dispersion of data transmission of each disk apparatus.

According to a first aspect of the present invention, there is provided an access method of a disk array connected to a network, comprising the steps of: performing a read operation of data by a plurality of disk apparatuses constituting the disk array in parallel with one another; and transmitting the read data onto the network in a data read end order of each disk apparatus in a transmission mode in which order and continuity of the data are guaranteed.

According to a second aspect of the present invention, there is provided a storage apparatus comprising: a plurality of disk apparatuses; disk control means for controlling read/write of the plurality of disk apparatuses in parallel with one another; and transmission means for transmitting data read from the plurality of disk apparatuses to a communication channel under control of the disk control means, wherein the transmission means include means for transmitting data read from the plurality of disk apparatuses under the control of the disk control means in a read end order of each disk apparatus in a transmission mode in which order and continuity of the data can be guaranteed.

According to a third aspect of the present invention, there is provided a storage apparatus comprising:

a disk array apparatus including a plurality of disk apparatuses constituting the array in accordance with a predetermined redundant arrays of inexpensive disks (RAID) level;

an interface which connects the disk array apparatus to a network; and

transmission means for transmitting data read from the plurality of disk apparatuses constituting the array onto the network every data read end of each of the plurality of disk apparatuses in a predetermined transmission mode in which order and continuity of the data can be guaranteed.

According to the present invention, the data of a disk apparatus B (Disk B) in which the data is first prepared is transmitted in the transmission mode in which the order and continuity of the data can be guaranteed, before the data of the disk apparatus A (Disk A) is prepared. By this transmission function, the data can efficiently be transmitted at a high speed regardless of dispersion of data transmission of each disk apparatus.

That is, according to the present invention, in the access method of the disk array connected via the network, a plurality of disk apparatuses constituting the disk array performs the read operation of the data in parallel with one another, and the data is transmitted onto the network in the data read end order of each disk apparatus in the transmission mode in which the order and continuity of the data are guaranteed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an explanatory view of an operation of a conventional RAID process;

FIG. 2 is an explanatory view of one example in which a protocol of iSCSI is used to transmit data to a host computer from a disk controller;

FIG. 3 is a block diagram showing a constitution of a system using a storage apparatus in one embodiment of the present invention;

FIG. 4 is a block diagram showing details of the disk controller shown in FIG. 3;

FIG. 5 is a flowchart showing an acceptance process of a read access request in the embodiment shown in FIG. 2;

FIGS. 6A and 6B are flowcharts showing a data transmission process of a disk apparatus unit in the embodiment shown in FIG. 3;

FIG. 7 is an explanatory view of an operation of an RAID process according to the present invention; and

FIG. 8 is an explanatory view showing an operation for data transmission to the host computer from the disk controller in detail in one embodiment of the present invention.

### DETAILED DESCRIPTION OF THE INVENTION

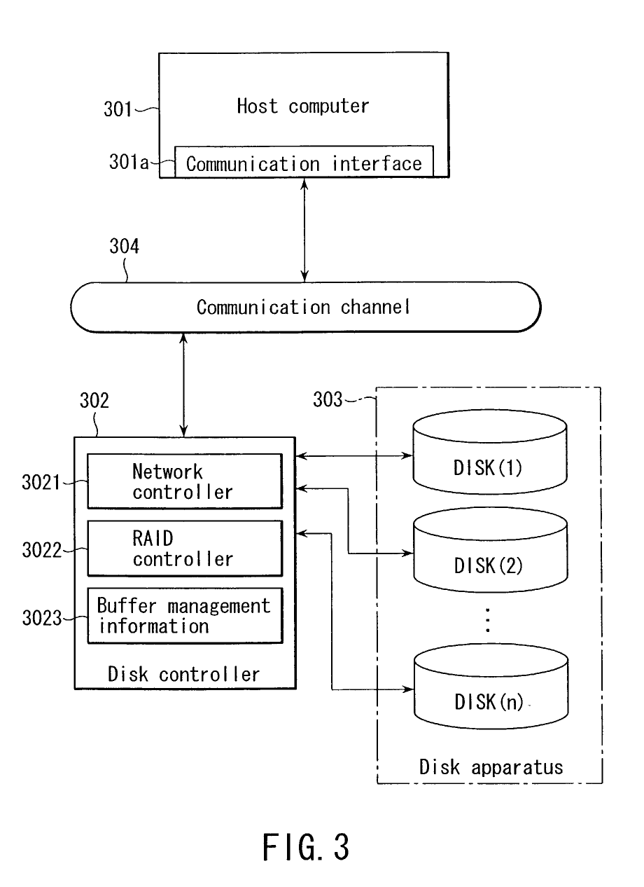

FIG. 3 is a block diagram showing a constitution of a system using a storage apparatus in one embodiment of the present invention.

The system shown in FIG. 3 includes elements such as a host computer 301, disk controller 302, disk array 303, and communication channel 304. The host computer 301 and disk controller 302 are connected to each other via a communication interface 301a and communication channel 304. In response to a request from the host computer 301, the disk controller 302 controls read/write access of the disk array 303.

The host computer 301 makes a read/write request of data to the disk controller 302 with respect to the disk array 303 as an object via the communication interface 301a and communication channel 304. In the communication interface 301a of the host computer 301, fractionated data of a packet received from the disk controller 302 via the communication channel 304 is prepared into continuous data keeping ordinality in accordance with a protocol header of each packet, and data is obtained to satisfy the read request.

The disk controller 302 is connected to the host computer 301 via the communication channel 304, and controls the read/write of the disk array 303 in response to the request from the host computer 301.

The disk controller 302 includes: a network controller 3021 which executes a transmission control of the read/write data; a RAID controller 3022 which controls an access of the disk array 303; and buffer management information 3023.

At a read access time of the disk array 303, on receiving a read end notice of each disk apparatus from the RAID controller 3022, the network controller 3021 uses a predetermined protocol (e.g., protocol conforming to iSCSI) which guarantees the division and ordinality of data to generate the protocol header which guarantees the order and continuity of the data. Furthermore, the disk controller 302 generates the packet based on the protocol header and the corresponding fractionated data read from each disk apparatus, and transmits the packet to the host computer 301 via the communication channel 304.

The RAID controller 3022 simultaneously has a read/write access to a plurality of disk apparatuses DISK(1), DISK(2), . . . , DISK(n) constituting the disk array 303 in parallel. At the read access time, the RAID controller 3022 informs the network controller 3021 of the read end of each disk apparatus by a unit including the disk apparatuses DISK(1), DISK(2), . . . , DISK(n), and transfers the corresponding fractionated data to the network controller 3021.

The buffer management information 3023 includes offset and size information of a data block to be read. For example, the buffer management information 3023 associates and stores the number of each disk apparatus constituting the disk array with an initial offset value. Furthermore, the buffer management information 3023 includes various flag information such as “NOT DONE” (data is not transmitted to the host computer) and “VALID” (data is read).

The disk array 303 includes a plurality of disk apparatuses DISK(1), DISK(2), . . . , DISK(n) in which, for example, hard disks are used as storage mediums and which constitute an array of RAID. In response to the request of the host computer 301, under the control of the RAID controller 3022, the data is simultaneously read/written with respect to the plurality of disk apparatuses DISK(1), DISK(2), . . . , DISK(n) constituting the array in parallel.

The communication channel 304 constitutes a network which connects the host computer 301 and disk controller 302. In this case, as a connection interface between the host computer 301 and disk controller 302, a protocol is used which guarantees the division and ordinality of the data and which conforms, for example, to iSCSI. Although SCSI is general as the interface of the disk controller 3022 and host computer 301, iSCSI exists as a standard constituted by extending SCSI to LAN. The iSCSI is defined using a TCP protocol on an IP network, fractionation of the data is permitted in the communication with another node, and the ordinality and continuity of data are guaranteed. In the TCP protocol the fractionation is allowed with respect to a stream having a connection. For a change of the order of the data being transmitted, it is possible to modify (recover) the data fractionated at a protocol level to an original order (data arrangement).

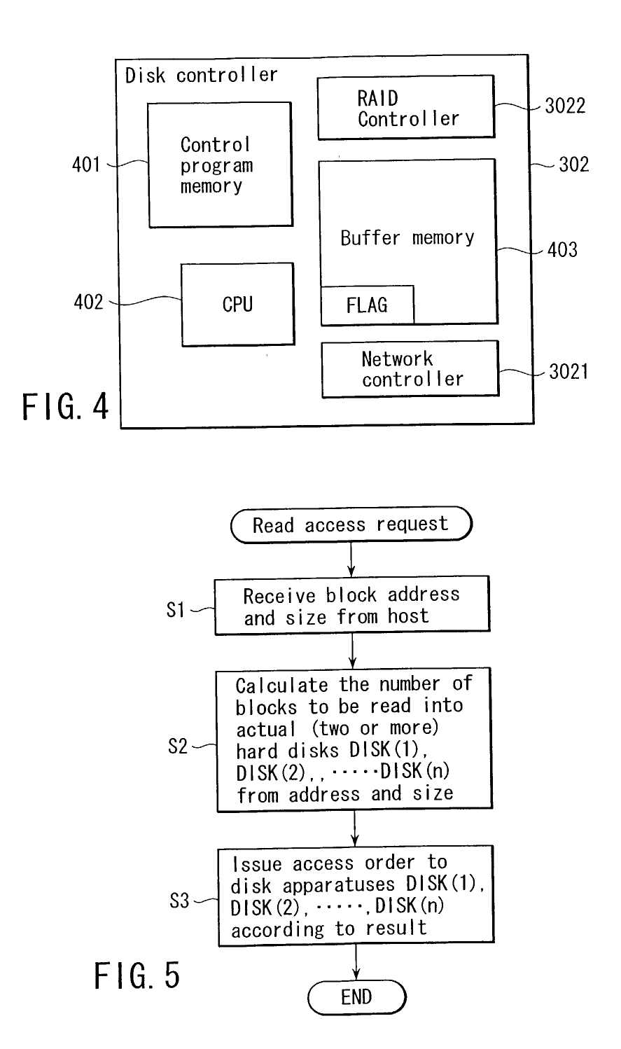

FIG. 4 is a detailed block diagram of the disk controller 302 shown in FIG. 3. As shown in FIG. 4, the disk controller 302 includes the PAID controller 3022, a buffer memory 403, the network controller 3021, a control program memory 401, and a CPU 402.

FIG. 5 is a flowchart showing a process at a time when the disk controller 302 receives a read access request from the host computer 301 via the communication channel 304 in one embodiment of the present invention.

On receiving the read access request from the host computer 301, the disk controller 302 receives an address and size of a block to be read/accessed from the host computer 301 in step S1. Subsequently, in step S2, the disk controller 302 calculates the number of blocks to be read by the actual hard disks DISK(1), DISK(2), . . . , DISK(n) from the received address and size. Next in step S3, the disk controller 302 issues an access command to the disk apparatuses DISK(1), DISK(2), . . . , DISK(n) according to a calculation result.

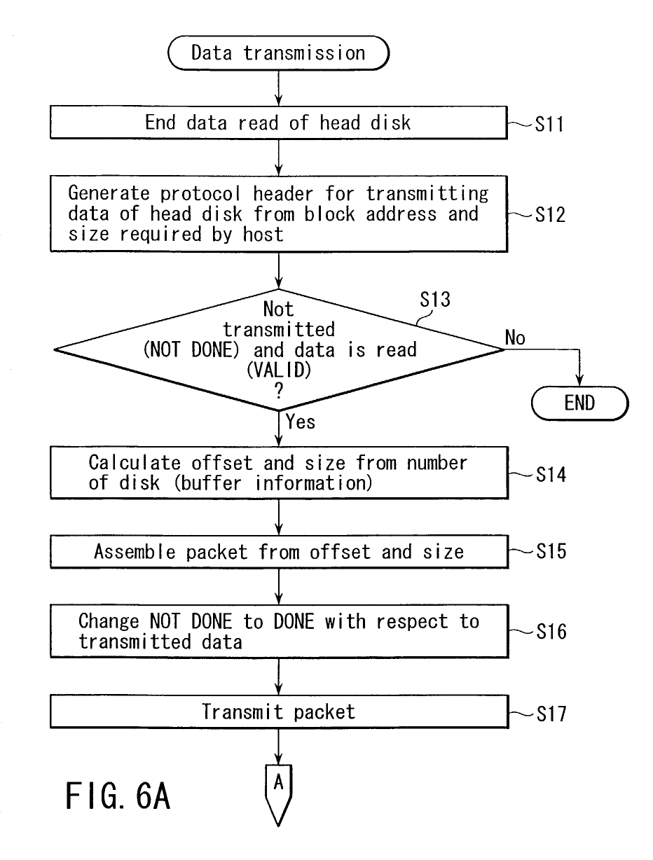

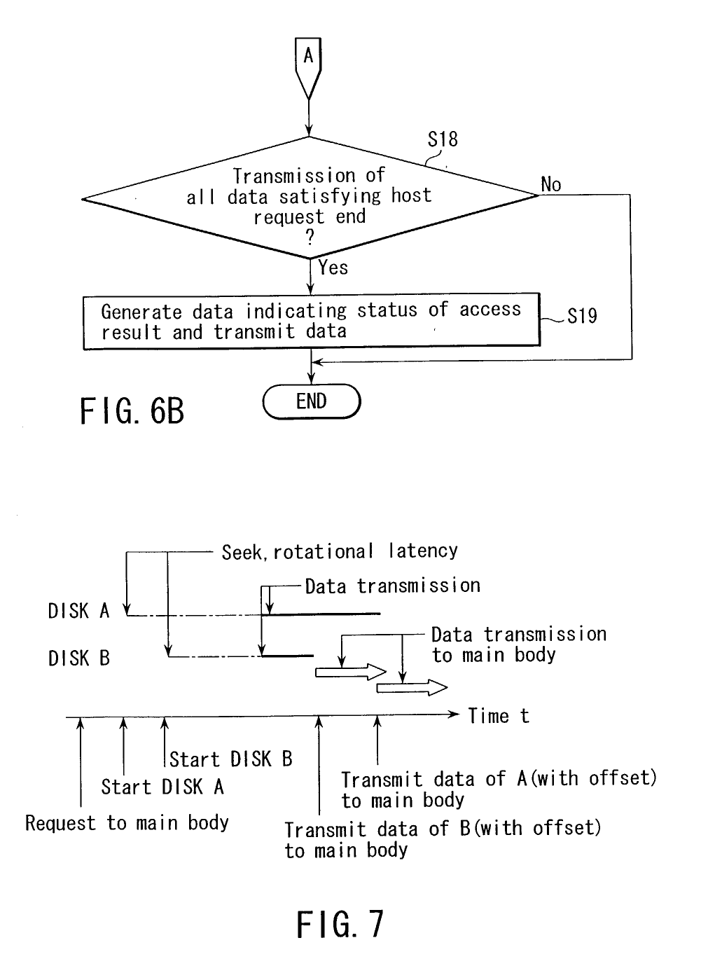

FIGS. 6A and 6B are flowcharts showing a data transmission process procedure of each of disk apparatuses DISK(1), DISK(2), . . . , DISK(n) constituting the disk array 303, executed by the disk controller 302, in one embodiment of the present invention.

In step S11 of FIG. 6A, when the data read of the hard disk ends, in step S12 the disk controller 302 generates the protocol header for transmitting the data of the hard disk from the block address and size required by the host computer 301. Next in step S13, the disk controller 302 judges whether the read data is not transmitted (NOT DONE) and the data is read (VALID). When the data is not transmitted and is read, in step S14, offset and maximum size are calculated from the number of the disk (buffer information). Next in step S15, the disk controller 302 assembles the packet from the offset and maximum size. Subsequently, in step S16, the disk controller 302 sets the flag information “NOT DONE” stored in the buffer memory 403 to “DONE” with respect to the data transmitted to the host computer 301. Next in step S17, the disk controller 302 transmits the packet.

Next in step S18, the disk controller 302 judges whether or not the transmission of the data satisfying the request of the host computer 301 has all ended. As a result of judgment, it is judged that the transmission of all the data satisfying the request of the host computer 301 has ended. Then in step S19, the disk controller 302 generates data indicating status of an access result, and transmits the data to the host computer 301.

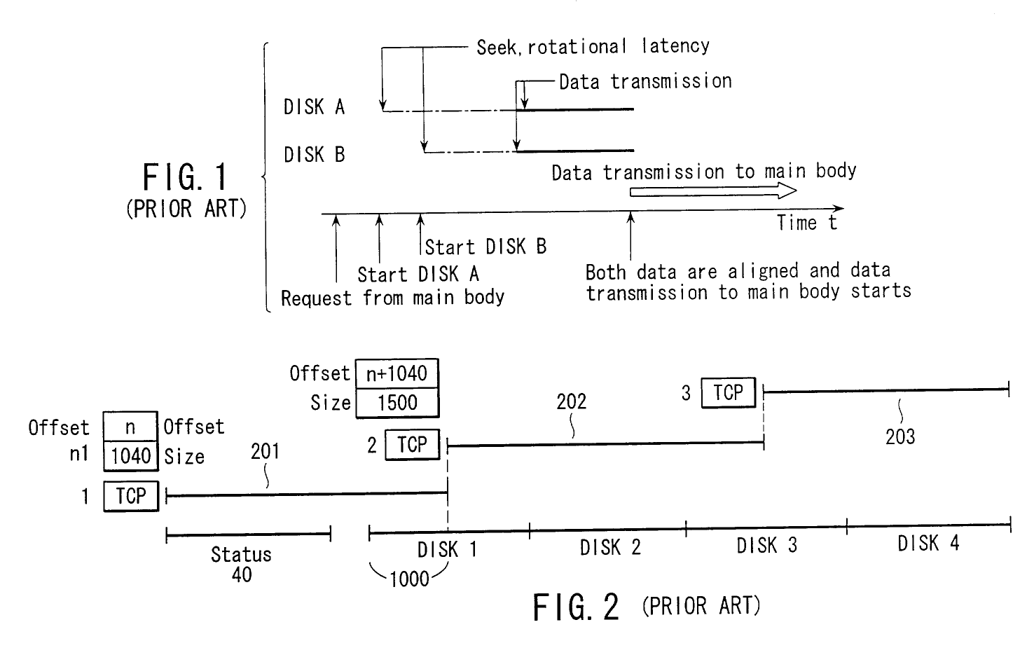

FIG. 7 is an operation explanatory view of an RAID process operation of the disk array connected to the network in one embodiment of the present invention in comparison with the conventional RAID operation shown in FIG. 1.

As shown in FIG. 7, the data of a disk array B (Disk B) in which the data is first prepared is transmitted in a transmission mode in which the order and continuity of the data can be guaranteed, before the data of a disk apparatus A (Disk A) is prepared. Following the data transmission, the data of the disk apparatus A (Disk A) in which the data is next prepared is transmitted in the transmission mode in which the order and continuity of the data can be guaranteed. By this transmission control function, the data can efficiently be transmitted at a high speed regardless of a dispersion of the data transmission of each disk apparatus.

An operation in one embodiment of the present invention will be described hereinafter with reference to the drawings.

On receiving the read access request of the disk array 303 from the host computer 301 via the communication channel 304, the network controller 3021 disposed in the disk controller 302 transmits the access request to the RAID controller 3022. The RAID controller 3022 calculates a physical data storage position (physical address) on the disk apparatuses DISK(1), DISK(2), . . . , DISK(n) constituting the disk array 303 from the block address and size of the access request, and issues a data read access command to the disk array 303 based on the calculated physical address (steps S1 to S3 of FIG. 5).

The disk array 303 follows the access command received from the RAID controller 3022, and starts the respective disk apparatuses DISK(1), DISK(2), . . . , DISK(n) constituting the array. When the respective disk apparatuses DISK(1), DISK(2), . . . , DISK(n) end the reading of the data, this is notified to the RAID controller 3022. The RAID controller 3022 transfers a read end notice of each of the disk apparatuses DISK(1), DISK(2), . . . , DISK(n) to the network controller 3021.

Upon receiving each read end notice from the disk apparatuses DISK(1), DISK(2), . . . , DISK(n) (step S11 of FIG. 6A), the network controller 3021 generates the protocol header which guarantees the order and continuity of the read data (fractionated data) from the block address and size required by the host computer 301 (step S12 of FIG. 6A).

Subsequently, the disk controller 302 judges whether the read data is not transmitted and the data is read (step S13 of FIG. 6A). Subsequently, the offset and maximum size are calculated from the number of the disk (packet information) (step S14 of FIG. 6A). Moreover, the packet is assembled from the offset and maximum size (step S15 of FIG. 6A). Subsequently, for the transmitted data, the flag information “NOT DONE” is changed to “DONE” indicating that the data has been transmitted (step S16 of FIG. 6A). Furthermore, the packet is transmitted to the host computer 301 via the communication channel 304. That is, without waiting for the read end of the disk apparatuses DISK(1), DISK(2), . . . , DISK(n) constituting the disk array, the network controller 3021 transmits the fractionated data of each of the disk apparatuses having ended the reading to the host computer 301 as a requester.

The process of transmitting the fractionated data of each disk apparatus to the host computer 301 as the requester (the steps S11 to S17 of FIG. 6A) is performed with respect to all the fractionated data of the disk apparatuses DISK(1), DISK(2), . . . , DISK(n) constituting the disk array 303 (step S18 of FIG. 6B). The status of the access result is generated, formed into the packet as the last fractionated data of the status, and transmitted. Thereby, the process in response to the access request from the host computer 301 ends (step S19 of FIG. 6B).

In this manner, without waiting for the read end of the respective disk apparatuses DISK(1), DISK(2), . . . , DISK(n) constituting the disk array 303, the network controller 3021 disposed in the disk controller 302 transmits the read fractionated data of each disk apparatus having ended the reading to the host computer 301 as the requester every read end. By this process function, the network controller can efficiently transmit the data satisfying the access request of the host computer 301 to the requester at a high speed regardless of the dispersion of the data transmission (read process) of each disk apparatus.

The example of the access process according to the above-described embodiment of the present invention is shown in FIG. 7 in comparison with the prior art (see FIG. 1). It is to be noted that a difference of the access process in the present invention shown in FIG. 7 from the prior art has already been described and therefore redundant description is avoided. It is also to be noted that in the embodiment all the fractionated data of the respective disk apparatuses (DISK(1), DISK(2), . . . , DISK(n)) constituting the disk array 303 are transmitted and thereafter the status of the access result is transmitted in the packet as the last fractionated data. To realize the status generation and packet transmission of the access result, in a time axis shown in FIG. 5, when the fractionated data of the disk apparatus A (Disk A) having ended the reading lastly is prepared, the status is generated. After the fractionated data of the disk apparatus A (Disk A) is transmitted, the status is transmitted as the final packet.

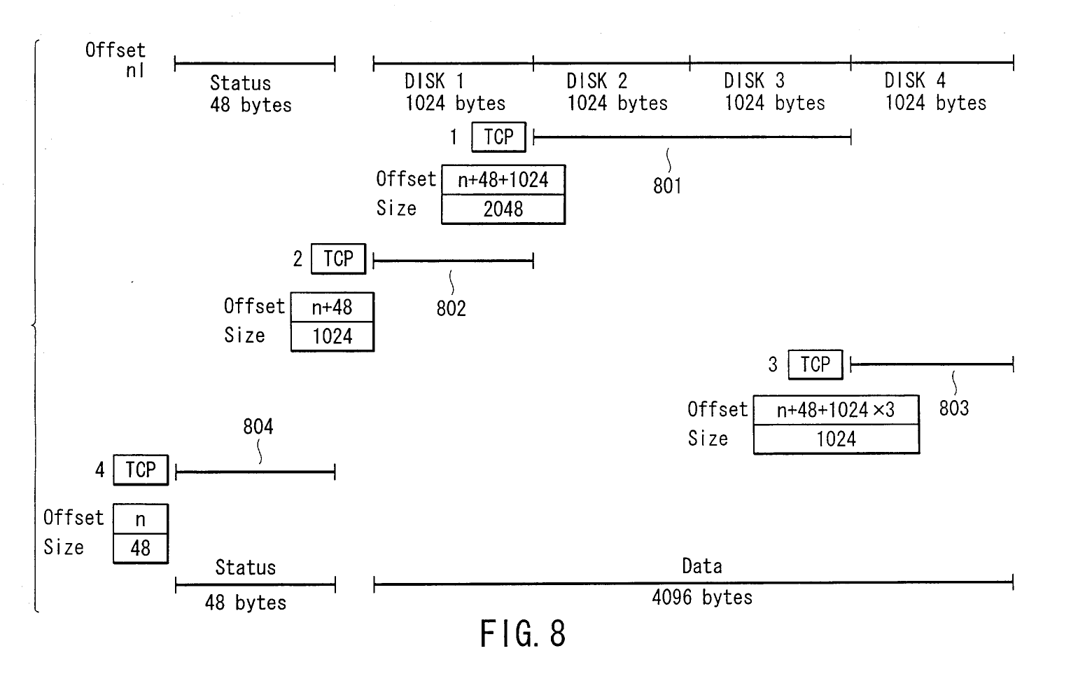

FIG. 8 is an explanatory view showing an operation for the data transmission to the host computer 301 from the disk controller 302 in detail in one embodiment of the present invention. In an example shown in FIG. 8, the disk array 303 includes four disk apparatuses. It is now assumed that disk apparatuses 2 and 3 has simultaneously read the data. Moreover, it is assumed that an initial offset value is “n” and status information is, for example, of 48 bytes. Furthermore, the block size read from each disk apparatus is, for example, 1024 bytes.

First, the disk controller 302 merges the data of disks 2 and 3, adds a TCP header to the data, and transmits the data to the host computer. That is, offset “n+48+1024” and size “2048” are calculated from the number of the disk (buffer information). Subsequently, the packet is assembled from the offset and size. Subsequently, the disk controller 302 transmits an assembled packet 801 to the host computer 301.

It is next assumed that the data of the disk apparatus 1 is read as shown in FIG. 8. In this case, the disk controller 302 calculates offset “n+48” and size “1024”, adds the TCP header, assembles a packet 802 from the offset and size, and transmits the packet 802 to the host computer 301.

It is next assumed that the data of the disk apparatus 4 is read as shown in FIG. 8. The disk controller 302 calculates offset “n+48+1024×3” and size “1024” from the number of the disk. Subsequently, the disk controller 302 adds the TCP header and assembles a packet 803 from the offset and size. Next the controller 302 transmits the packet 803 to the host computer 301.

All the data is read in this manner. Therefore, the status information indicating that the data has successfully been read is generated, offset “n” and size “48” are calculated, and a packet 804 is assembled and transmitted to the host computer 301.

Since the offset information is added to the received packet, the host computer can return the packet to an original arrangement order.

It is to be noted that in the above-described embodiment, iSCSI is used as the protocol for use in the transmission between the host computer and disk controller, but the present invention can be realized by any interface having a mechanism such that the order of the packet is known by some data (ID or sequence number).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An access method of a disk array connected to a network, comprising the steps of:
performing a read operation of data by a plurality of disk apparatuses constituting said disk array in parallel with one another; and
transmitting said read data onto said network in a data read end order of each of the disk apparatuses in a transmission mode in which order and continuity of the data are guaranteed.

2. The method according to claim 1, further comprising the steps of: using a protocol which guarantees the order and continuity of data to form the data into a packet and transmitting the packet in a data read end stage of each disk apparatus, before all the data read from said respective disk apparatuses by the parallel operation of said plurality of disk apparatuses is prepared.

3. The method according to claim 1, further comprising the step of: transmitting status information with respect to the data as a last fraction with transmission end of all the data read from said respective disk apparatuses by the parallel operation of said plurality of disk apparatuses.

4. The method according to claim 2, further comprising the steps of: defining said protocol in conformity to a transmission control protocol/internet protocol (TCP/IP); and using fractionated data read from said respective disk apparatuses and a protocol header which guarantees the order and continuity of the data to constitute the packet.

5. A storage apparatus comprising:
a plurality of disk apparatuses;
a disk controller configured to control read/write of said plurality of disk apparatuses in parallel with one another; and
a transmitter configured to transmit data read from said plurality of disk apparatuses to a communication channel under control of said disk controller, said transmitter including means for transmitting the data read from said plurality of disk apparatuses under the control of said disk controller in a read end order of each of said disk apparatuses in a transmission mode in which order and continuity of the data can be guaranteed.

6. A storage apparatus comprising:
a disk array apparatus including a plurality of disk apparatuses constituting an array in accordance with a predetermined redundant arrays of inexpensive disks (PAID) level;
an interface which connects the disk array apparatus to a network; and
a transmitter configured to transmit data read from the plurality of disk apparatuses constituting said array onto said network every data read end of each of said plurality of disk apparatuses in a predetermined transmission mode in which order and continuity of the data can be guaranteed.

7. The storage apparatus according to claim 5, wherein said transmitter uses a protocol which guarantees the order and continuity of the data to form the data into a packet and transmits the packet in a data read end stage of each disk apparatus, before all the data read from said respective disk apparatuses by the parallel operation of said plurality of disk apparatuses is prepared.

8. The storage apparatus according to claim 6, wherein said transmitter uses a protocol which guarantees the order and continuity of the data to form the data into a packet and transmits the packet in a data read end stage of each disk apparatus, before all the data read from said respective disk apparatuses by the parallel operation of said plurality of disk apparatuses is prepared.

9. The storage apparatus according to claim 5, wherein said transmitter includes means for transmitting status information with respect to the data as a last fraction with transmission end of all the data read from said respective disk apparatuses by the parallel operation of said plurality of disk apparatuses.

10. The storage apparatus according to claim 6, wherein said transmitter includes means for transmitting status information with respect to the data as a last fraction with transmission end of all the data read from said respective disk apparatuses by the parallel operation of said plurality of disk apparatuses.

11. The storage apparatus according to claim 7, wherein said protocol is defined in conformity to TCP/IP, and fractionated data read from said respective disk apparatuses and a protocol header which guarantees the order and continuity of the data are used to constitute the packet.

12. The storage apparatus according to claim 8, wherein said protocol is defined in conformity to TCP/IP, and fractionated data read from said respective disk apparatuses and a protocol header which guarantees the order and continuity of the data are used to constitute the packet.

13. An access method of a disk array connected to a host computer through a network via a disk controller including: a network controller which receives a read access request of the disk array from the host computer via a communication channel and transmits the access request to redundant arrays of inexpensive disks (RAID); and a RAID controller which calculates a physical address of a disk apparatus constituting the disk array from a block address and size of said access request and issues a data read access command to the disk array based on the calculated physical address, and a communication channel, the method comprising the steps of:
receiving the read access request of the disk array from the host computer via the communication channel and transmitting the access request to the RAID controller;
calculating the physical address on the disk apparatus constituting the disk array from the block address and size of said access request and issuing the data read access command to the disk array based on the calculated physical address by the RAID controller;
starting the respective disk apparatuses constituting the disk array in accordance with the access command received from the RAID controller by the disk array;
notifying said RAID controller of the data read end by each of the disk apparatuses;
transferring a read end notice of each disk apparatus to the network controller by the RAID controller; and
receiving the read end notice from each disk apparatus, generating a protocol header which guarantees order and continuity of the read data from the block address and size required by the host computer, generating a packet based on the protocol header and corresponding fractionated data, and transmitting the packet to the host computer via the communication channel by the network controller.
